(19) United States
(12) Patent Application Publication
(10) Pub. No.: US 2009/0146911 A1
(43) Pub. Date: Jun. 11, 2009

(54) PRESENTATION APPARATUS HAVING DUAL DISPLAYS

(76) Inventor: Dong Youn Kang, Busan (KR)

Correspondence Address: IPLA P.A., 3580 WILSHIRE BLVD., 17TH FLOOR, LOS ANGELES, CA, 90010, US

(21) Appl. No.: 12/302,963

(22) PCT Filed: Mar. 12, 2007
(86) PCT No.: PCT/KR2007/001187

§ 371 Date: Dec. 1, 2008

(30) Foreign Application Priority Data
Jun. 8, 2006 (KR) 20-2006-0015355

(51) Int. Cl. G09G 5/00

(52) U.S. Cl. 345/1.3

(57) ABSTRACT

Disclosed is a dual-display presentation apparatus. The dual-display presentation apparatus comprises an auxiliary member having a first display unit on a side thereof, a main body having a second display unit on a side thereof and having a support member and a depression for receiving the support member on the other side thereof, and a connection member, which is a hinge unit, combining the auxiliary member and the main body, in which locations of the auxiliary member and the main body can be adjusted by swiveling and tilting the connection member. Using the dual-display presentation apparatus, work efficiency and deal-making efficiency can be enhanced.

### TECHNICAL FIELD

The present invention relates to a presentation apparatus, and more particularly to a dual-display presentation apparatus having a dual display system which enables people to make a deal with reference to contents displayed on screens while they face each other.

### BACKGROUND ART

The more society develops, the more general salespeople call on customers in person. This trend is common to all business fields, particularly in the pharmaceutical, insurance, banking, and real estate industries. Accordingly, cost-effective and efficient presentation methods must be used.

Generally, a salesperson explains his or her products to his or her customers by providing documents such as pamphlets or brochures to his or her customers or using a notebook computer to display the contents of a presentation that explains the products. The documents, such as pamphlets or brochures, have the advantage of attracting the attention of customers for a short time, but most of them are easily thrown into a trash bin. This incurs increased expenses for the companies, salespeople, and customers. Recently, in order to solve this problem, salespeople usually carry notebook computers and explain the products or services that they provide to customers using the notebook computers. However, due to the long booting period, this method has the disadvantage of reducing customers' interest in their products. Further, in the case of performing a presentation using a notebook computer, there are problems in that it takes too long to run application programs in a notebook computer and in that a lot of expenses are incurred because memory devices having large capacity are needed to store the application programs and the high level platform is needed to run the application programs. Further, for effective presentations, an apparatus that projects beams is occasionally used. In this case, since a notebook computer and a beam projector must both be carried, it is troublesome. In the case of using a notebook computer for performing a presentation, there is still a problem in that a salesperson and his or her customers must look at the contents of the presentation in the same direction. Accordingly, it is troublesome in that the salesperson must record the customer's responses and demands on paper or as a file.

In order to solve the above-described problems, an improved presentation apparatus was developed by the applicant of the present patent application, and was disclosed in Korean Patent Application No. 10-2005-29086. The presentation apparatus disclosed in Korean Patent Application No. 10-2005-29086 includes an output means for outputting the contents of a presentation for members to be provided with the presentation, enables a presenter to effectively conduct a presentation using a beam projector and to conduct video recording or audio recording with respect to the process of presentation, and can decrease memory usage, so that the presentation apparatus can be widely used.

The applicant of the present application now provides another presentation apparatus having a dual-display system, which is improved over the presentation apparatus disclosed in Korean Patent Application No. 10-2005-29086. This apparatus can enhance work efficiency thanks to two displays units when the apparatus is not used for presentation purposes and is convenient to use in the case in which a main board and a main display unit are integrated into a flat panel-shaped body thanks to the development of surface mounting technologies and the trend of emerging thin film-type electronic devices.

### DISCLOSURE OF INVENTION

### Technical Problem

Accordingly, the present invention has been devised in consideration of the aforementioned problems and conditions, and it is an object of the present invention to provide a dual-display presentation apparatus having a dual-display system which helps a user enhance work efficiency using two display monitors and which can output the contents of a presentation for members to be provided with a presentation.

It is a further object of the present invention to provide a dual-display presentation apparatus having a dual-display system, which is convenient to use and has a small size because a support member is added to the back of a main body in the case in which a main board and a main display unit are combined into a flat panel-shaped body.

### Technical Solution

In order to achieve the above described advantageous effects and objects, in accordance with the present invention, there is provided a dual-display presentation apparatus comprising an auxiliary member having a first display unit on one side thereof, a main body having a second display unit on one side thereof and having a support member and a depression for receiving the support member on the other side thereof, and a connection member being a hinge unit combining the auxiliary member and the main body, in which the locations of the auxiliary member and the main body can be adjusted by swiveling and tilting the connection member.

The presentation apparatus may further comprise a main board on one side of the main body, and the main board and the second display monitor are integrated into an ultra-thin body. A selection button may be further provided on one side of the auxiliary member.

### ADVANTAGEOUS EFFECTS

As can be seen through the embodiment of the present invention, the present invention provides a dual-display presentation apparatus having a dual-display system which enables a user to enhance job efficiency using two display units and which can output the contents of a presentation.

In the case in which a main board and a main display unit are combined into a flat panel-shaped main body, since a support member is provided on the back surface of the main body, the presentation apparatus according to the present invention has a small size and can be conveniently used.

### BRIEF DESCRIPTION OF THE DRAWINGS

FIG. 1 is a block diagram illustrating the inner structure of a dual-display presentation apparatus according to one embodiment of the present invention;

FIG. 2 is a schematic diagram illustrating a computing environment in which a dual-display presentation apparatus according to one embodiment of the present invention can be partially and fully implemented;

FIG. 3 and FIG. 4 are perspective views illustrating the appearance of a dual-display presentation apparatus according to one embodiment of the present invention;

FIG. 5 is a front perspective view illustrating a dual-display presentation apparatus according to one embodiment of the present invention, which is in the state of being used for a presentation;

FIG. 6 is a front view illustrating a dual-display presentation apparatus according to one embodiment of the present invention, which is in the state of being used for general office work, rather than a presentation;

FIG. 7 is a side perspective view illustrating a dual-display presentation apparatus according to one embodiment of the present invention, in which an auxiliary member is folded;

FIG. 8 is a side perspective view illustrating a dual-display presentation apparatus according to one embodiment of the present invention, in which an auxiliary member is expanded;

FIG. 9 is a perspective view illustrating a rear view of a dual-display presentation apparatus according to one embodiment of the present invention; and

FIG. 10 is a view illustrating an example of use of the dual-display presentation apparatus according to one embodiment of the present invention for general office work.

### BEST MODE FOR CARRYING OUT THE INVENTION

A dual-display presentation apparatus according to embodiments of the present invention will be described below with reference to the accompanying drawings.

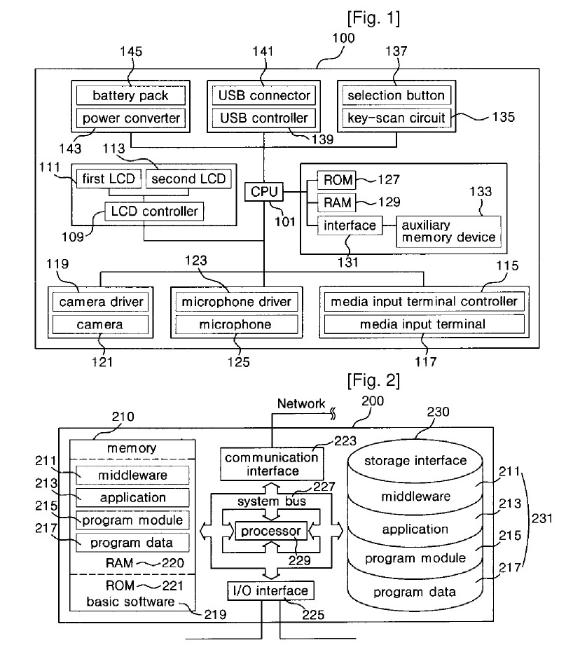

FIG. 1 is a block diagram illustrating the inner structure of a dual-display presentation apparatus according to one embodiment of the present invention.

Referring to FIG. 1, the dual-display presentation apparatus 100 includes a power supply unit, a communication unit, a selection unit, a liquid crystal display (LCD) unit, a storage unit, a microphone unit, a camera unit, a media input unit, and a central processing unit (CPU) 101. Here, the dual-display presentation apparatus 100 comprises an auxiliary member and a main body. Respective elements of the dual-display presentation apparatus will be explained below in detail.

The power supply unit includes a battery pack 145, for supplying power needed to drive the dual-display presentation apparatus 100, and a power converter 143 for converting a voltage value of constant input power to a variety of voltage values to be input to respective elements of the apparatus. According to one embodiment of the present invention, the battery pack 145 can be substituted with a power connector through which external power is input. The power converter 143 receives a control signal from the CPU 101, converts the voltage of the input power to a voltage to be input to a specific element, and then supplies the converted voltage to the specific element. The element to be used is determined according to the control signal.

The communication unit may include a variety of interface devices for enabling the presentation apparatus to communicate with other computer systems, for example, a personal computer. For the sake of making a convenient explanation, the communication unit is, for example, a universal serial bus (USB) port. The communication unit includes a USB connector 141 for connection to other systems and a USB controller 139. Through the USB port 141 and 139, communication between other systems and the presentation apparatus according to the present invention can be performed. That is, thanks to the USB port 141 and 139, it is possible to download document files for general office work and presentations into the presentation apparatus from other computer systems and upload the result of general office work or recorded video or audio files containing the responses of listeners (customers) provided with a presentation, which are made using the presentation apparatus according to the present invention, to other computer systems.

The selection unit includes a plurality of selection buttons 137 which are set to perform preset functions or can enable a plurality of functions to be set when they are selected, and a key-scan circuit 135 for confirming which button is selected. The selection unit can be installed to the auxiliary member of the dual-display presentation apparatus.

According to the preferred embodiment of the present invention, the selection unit can be substituted with a user interface implemented as software and displayed on the liquid crystal display unit. In this case, the liquid crystal display unit may have a touchscreen function. Presenters performing a presentation, such as professional salespeople whose main job is giving presentations, control respective elements of the dual-display presentation apparatus using the selection unit or an external keyboard, which will be described below, or control the contents of general office work or presentations to be presented to listeners.

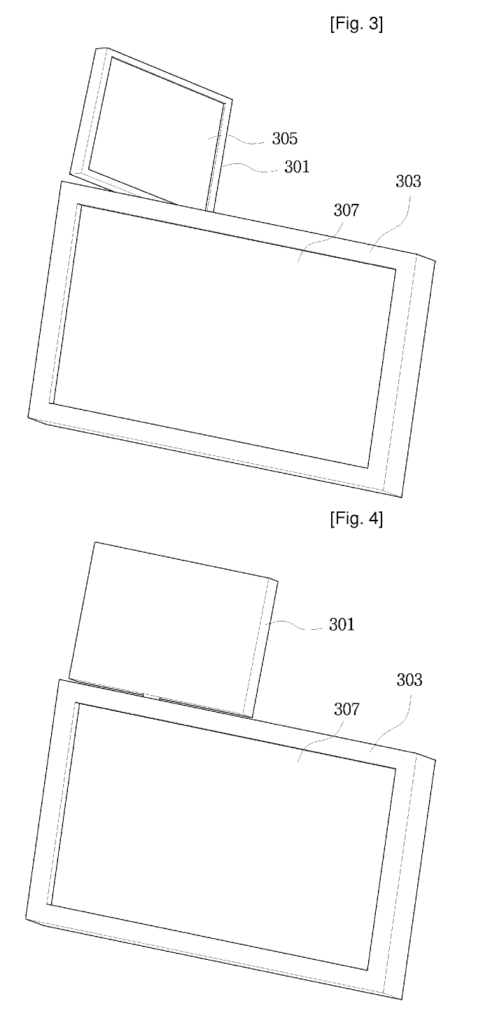

The liquid crystal display (LCD) unit includes a first LCD 111 for displaying files for general office work and presentations, a second LCD 113 for displaying the files for presentations and the interface which is used to control the process of displaying the files for presentations, and an LCD controller 109 for controlling the first LCD 111 and the second LCD 113. The first LCD 111 is disposed on one side of the auxiliary member of the dual-display presentation apparatus, and the direction of the first LCD 111 is adjusted in a manner such that it is oriented towards a user when it is used for the purpose of general office work and to listeners (people to be provided with a presentation) when it is used for a presentation. The second LCD 113 is disposed on top of the main body of the dual-display presentation apparatus 100 so that a user or a person who performs a presentation can look at it. The relationship between the locations of the first LCD 111 and the second LCD 113 is disclosed in detail in FIG. 3 through FIG. 10. The first LCD 111 and the second LCD 113 may be implemented so as to display the same contents or different contents, respectively, when they are used for the purpose of general office work, but to display the same contents when they are used for a presentation. According to the preferred embodiment of the present invention, when they are used for a presentation, the first LCD 111 will display the contents of the presentation, and the second LCD 113 will display a control screen by which the display of the presentation contents on the first LCD 111 will be controlled.

The storage unit includes a read only memory (ROM) device 127 storing a driving program for driving the dual-display presentation apparatus, a random access memory (RAM) device 129 for temporarily storing data, an auxiliary memory device 133 storing files containing presentation contents, and an interface device 131 for interfacing between the auxiliary memory device 133 and the CPU 101. According to the preferred embodiment of the present invention, the auxiliary memory device 133 may be a memory card such as MMC, SMC or flash memory, which has large capacity and a small size. According to another embodiment of the present invention, the auxiliary memory device 133 can be built-in, or can be a discrete device.

The microphone unit includes a microphone 125 and a microphone driver 123 for driving the microphone, and the camera unit includes a camera 122 and a camera driver 119 for driving the camera 122. The microphone 125 and the camera 122 perform video recording or audio recording of the responses of people (customers) provided with a presentation, or perform video recording or audio recording of the presentation of a presenter (salesperson) who performs a presentation.

The media input unit includes a media input terminal 117 including an RGB terminal for receiving an external media input signal and a media input terminal controller 115 for controlling the media input terminal 117.

The CPU 101 generates control signals for controlling every element of the dual-display presentation apparatus 100, and transmits the control signals to control respective elements, thereby controlling all the elements. The CPU 101 transmits a control signal to a USB controller 139 in order to control the USB port, a control signal to the key-scan circuit 135 in order to control the selection unit, a control signal to the power converter 143 in order to control the power supply unit, a control signal to the LCD controller 109 in order to control the LCD unit, a control signal to the ROM device 127, the RAM device 129, and the interface unit 131 in order to control the storage unit, a control signal to the microphone driver 123 in order to control the microphone unit, a control signal to the camera driver 119 in order to drive the camera unit, and a control signal to the media input terminal controller 115 in order to control the media input unit.

FIG. 2 is a schematic diagram illustrating a computing environment in which a dual-display presentation apparatus according to one embodiment of the present invention can be partially and fully implemented.

The computing environment shown in FIG. 2 is provided as an example to help people understand the computing environment, but the computing environment shown in FIG. 2 does not limit the scope of the present invention. The computing environment must not be construed to place a limitation on any one of respective elements or on any combination of respective elements shown in the exemplary environment.

The computing environment 200, which can be implemented using the above-described dual-display presentation apparatus, can be implemented through the configuration of elements of general or customized computing systems or environmental elements. Configuration elements or environmental elements commonly and widely used include a personal computer, a server computer, a variety of kinds of thin clients (thin clients) or a variety of kinds of thick clients. The computing environment can include lap-top computers, hand-held personal computers, programmable home appliances, network personal computers, minicomputers, mainframes, game console devices, personal digital assistants (PDA), mobile terminals and a distributed computing environment including the above-described systems.

The dual-display presentation apparatus 100 includes a general-purpose computing system having the structure of a computer. Configuration elements of the computer can include one or more processors 229, system memory 210, and a system bus 227 for connecting a plurality of elements such as the processors to the system memory 210. The processor 229 controls the dual-display presentation apparatus 100 by processing a plurality of execution commands and communicates with other electronic devices and computing devices.

The system bus 227 includes a memory bus, a memory controller, a peripheral device bus, a local bus with a variety of bus structures, and a processor bus, and can have a variety of bus structures. For example, the bus structure may be an Industry Standard Architecture (ISA) bus, a Micro Channel Architecture (MCA) bus, an Enhanced ISA (EISA) bus, a Video Electronics Standards Association (VESA) local bus, or a Peripheral Component Interconnects (PCI) bus.

The dual-display presentation apparatus 100 generally includes a variety of computer-readable media. These media include a medium which can be accessed by a computer device, a volatile or nonvolatile medium, or a removable or non-removable medium. The system memory 210 includes computer-readable media such as a volatile memory device, a RAM device 220, and a nonvolatile memory device, that is, ROM 221. For example, a basic input/output system (BIOS) 219 containing basic routines which are helpful to transfer information between elements of a computing device during a start-up period are stored in the ROM device 221. The RAM device 220 can be instantly accessed by the processor 229 and contains program modules which are running.

The computing device can include removable, non-removable, volatile and nonvolatile computer storage media. The computer storage medium includes a hard disk drive 231 for reading from and writing into a non-removable and nonvolatile magnetic medium (not shown), a magnetic disk drive for reading from and writing into a removable and nonvolatile magnetic disk such as a floppy disk, and an optical disk drive for reading from and writing into a removable and nonvolatile optical disk such as a CD-ROM, DVD-ROM, or other optical medium.

The hard disk drive 231, the magnetic disk drive, and the optical disk drive are connected to the system bus 227 via one or more data media interfaces 230. Alternatively, the hard disk drive 231, the magnetic disk drive, and the optical disk drive can be connected to the system bus 227 via a SCSI interface.

Disk drives and computer-readable media provide a nonvolatile storage space for computer-readable commands, data structures, program modules, and data related to the computing device. The hard disk, the removable magnetic disk and the removable optical disk are disclosed as an example, but it must be understood that other kinds of computer-readable media, which can store computer-accessible data, such as magnetic cassette tape or other magnetic storage devices; flash memory cards; other optical storage media, such as CD-ROM and digital versatile disks (DVD); RAM; ROM; and electrically-erasable programmable read-only memories (EEPROM) can be used to implement the computer system and environment.

For example, one piece of middleware 211, one or more application programs 213, program modules 215 and a plurality of program modules including program data 217 can be stored in the hard disk 231, the magnetic disk, the optical disk, the ROM device 221, and the RAM device 220. The middleware 221, the one or more application programs 213, the program modules 215, the program data 217 and combination thereof can include a program component. The computing device can include a variety of computer-readable media, identified as communication media.

The communication media implement data as a modulated data signal, such as computer-readable commands, data structures, program modules, carrier waves, or transmission mechanisms, and include an information transfer medium. The term “modulated data signal” means a signal having a characteristic set of one or more signals or a signal modulated in a manner such that information therein is encoded. For example, communication media include wired media such as a wired network or direct-wired connection, or wireless media such as acoustic, RF, infrared, and other wireless media, but the communication media are not limited thereto.

Various combinations thereof are included in the range of computer-readable media. A user can input commands and information into the computing system using input devices, an input device and a pointing device, such as a mouse. Other input devices such as a microphone, joystick, game pad, controller, satellite dish, serial port, and scanner can be used. Such input devices are connected to the processor 229 via the input/output (I/O) interfaces 225 connected to the system bus 27, but also can be connected to the processor 229 via interface devices and bus structures, such as parallel ports, game ports, and a universal serial bus (USB).

An output device also can be connected to the system bus 227 via the I/O interface 225. The computing device can be run in a networked environment through logical connections between one or more remote computers or other remote computing devices. For example, the remote computing device can be a personal computer, a portable computer, a server, a router, a network computer, a peer-to-peer device or a common network node.

The remote computing device is a personal computer that partially or fully includes the above-described elements and features with respect to computing devices. The logical connection between the computing device and the remote computer is a local area network (LAN) or a wide area network (WAN).

The networking environment is common in offices and enterprise-wide computer networks, and includes intranets and the Internet. When the computing device is implemented in the LAN networking environment, the computing device is connected to the LAN via a network interface device or a network adaptor. When the computing device is implemented in a WAN networking environment, the computing device generally includes a modem or other means to enable communication through the WAN.

The model which can be built in or be a discrete device can be connected to the system bus 227 through the I/O interface device 225 or other proper mechanisms. Under the networked environment which is shown, program modules stated above regarding the computing device or parts thereof can be stored in a remote memory storage device.

FIG. 3 and FIG. 4 are perspective views illustrating the appearance of a dual-display presentation apparatus according to one embodiment of the present invention.

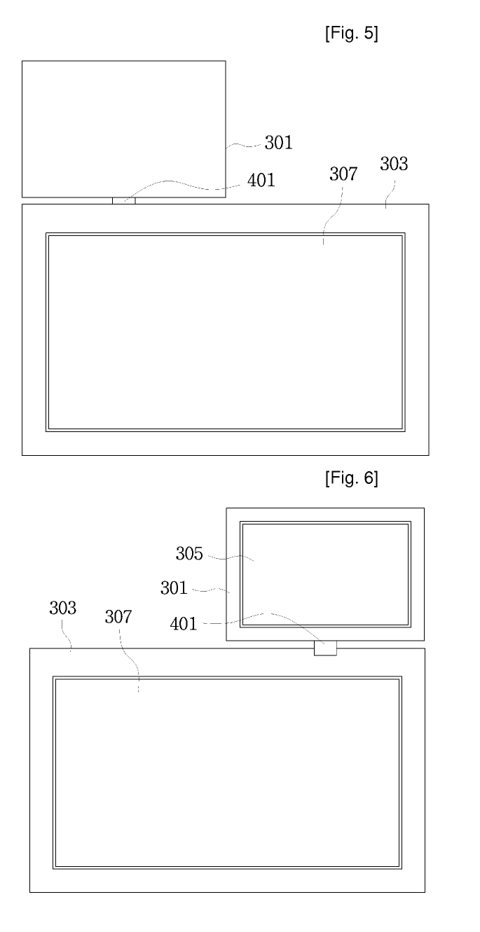

Referring to FIG. 3 and FIG. 4, the dual-display presentation apparatus 100 includes an auxiliary member 301 and a main body 303. A first LCD 305 is disposed on one side of the auxiliary member 301, and a second LCD 307 is disposed on one side of the main body 303. Thanks to the connection member (not shown) combining the main body 303 and the auxiliary member 301, the direction of the first LCD 305 can be adjusted in a manner such that the first LCD 305 is oriented towards a user when the apparatus is used for the purpose of general office work, and is oriented towards a person provided with a presentation when the apparatus is used for the presentation. FIG. 3 illustrates the dual-display presentation apparatus in which the auxiliary member 301 is being moved with respect to the main body 303 by the connection member, and FIG. 4 illustrates the dual-display presentation apparatus in which the location of the auxiliary member 301 is completely adjusted with respect to the main body 303 by the connection member so that the dual-display presentation apparatus is ready for a presentation. The connection member and location of the first LCD 305 can be adjusted, as will be explained in detail with reference to FIG. 5 through FIG. 8.

The second LCD 307 is disposed on top of the main body of the dual-display presentation apparatus so that a user or a person who conducts a presentation can look at it. On the first LCD 305 and the second LCD 307, the same or different contents can be displayed according to a user's manipulation when the dual-display presentation apparatus is used for the purpose of general office work. However, in the case in which the dual-display presentation apparatus is used for the purpose of presentation, the same contents are displayed on the first LCD 305 and the second LCD 307. According to another embodiment of the present invention, presentation contents are displayed on the first LCD 305 and a control screen which can be used to control the first LCD 305 to display the presentation contents thereon can be displayed on the second LCD 307 in the case in which the apparatus is used for a presentation. On the other side of the auxiliary member 301, a plurality of selection buttons (not shown) can be disposed so that a user or a person performing a presentation can select one of them in order to perform predetermined functions.

FIG. 5 is a front perspective view illustrating a dual-display presentation apparatus according to one embodiment of the present invention, which is in the state of being used for a presentation, and FIG. 6 is a front perspective view illustrating a dual-display presentation apparatus according to one embodiment of the present invention, which is in the state of being used for the purpose of general office work, rather than for a presentation.

Referring to FIG. 5 and FIG. 6, the dual-display presentation apparatus 100 includes the auxiliary member 301, the first LCD 305 disposed on one side of the auxiliary member, the main body 303, the second LCD 307 disposed on one side of the main body 303, and the connection member 401 for combining the auxiliary member 301 and the main body 303. The connection member 401 may be a hinge member, which can enable an object to swivel and tilt. The location of the auxiliary member 301 can be adjusted with respect to the main body 303 in order to switch the presentation apparatus 100 from a presentation mode (shown in FIG. 5) to a general office work mode (shown in FIG. 6) or vice versa.

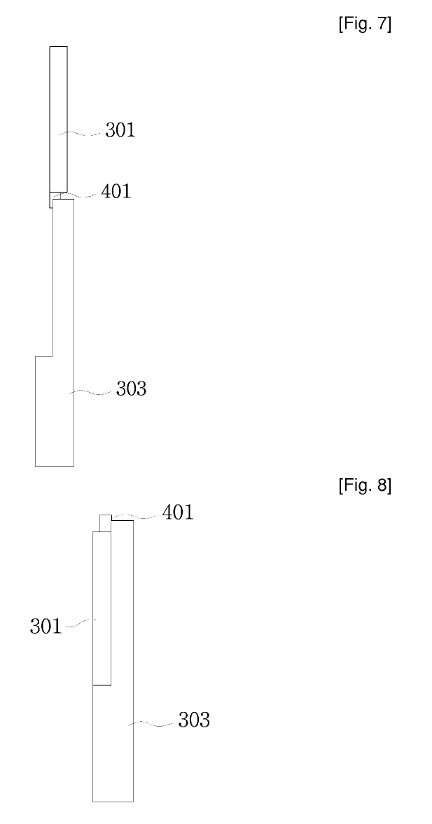

FIG. 7 is a side perspective view illustrating a dual-display presentation apparatus according to one embodiment of the present invention, in which an auxiliary member is folded, and FIG. 8 is a side perspective view illustrating a dual-display presentation apparatus according to one embodiment of the present invention, in which an auxiliary member is expanded.

Referring to FIG. 7 and FIG. 8, the auxiliary member 301 can be folded or expanded with respect to the main body 303 using the connection member 401, which is a hinge member capable of enabling an object to be swiveled and tilted. As shown in FIG. 4, in the state in which the auxiliary member 301 is folded using the connection member 401, a user can use only the second LCD disposed on one side of the main body 303 for the purpose of general office work, without using the first LCD disposed on one side of the main body 303. In the state in which the auxiliary member 301 is folded using the connection member 401, the contents of a presentation can be displayed on the first LCD disposed on one side of the auxiliary member 301 by a user's manipulation when the presentation apparatus is used for a presentation.

In the state in which the auxiliary member 301 is expanded by the connection member 401 (see FIG. 8), a user can use both the first LCD disposed on one side of the auxiliary member 301 and the second LCD disposed on one side of the main body 303 for the purpose of general office work or giving a presentation. When the presentation apparatus is used for the purpose of general office work, the first LCD and the second LCD are adjusted to face the same direction, and they are adjusted to be oriented in opposite directions for a presentation.

A main board is disposed on the other side of the main body 303. According to the application of surface mounting technologies, the main board and the second LCD can be integrated into a flat panel-shaped single body.

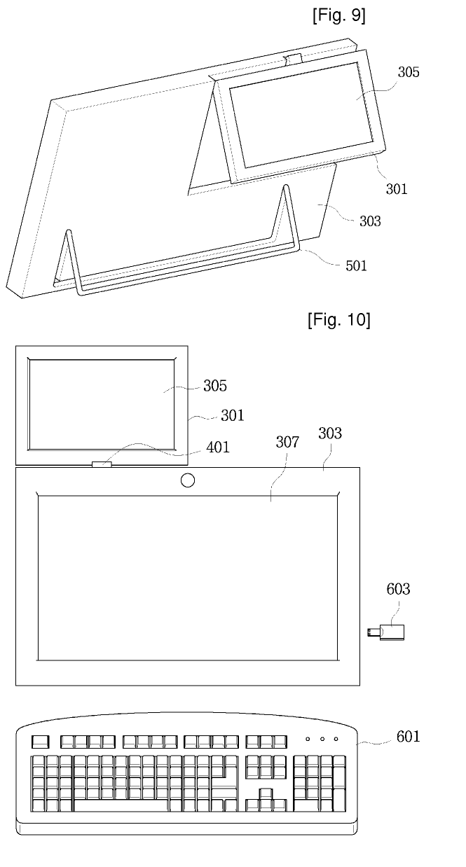

FIG. 9 illustrates a rear view of a dual-display presentation apparatus according to one embodiment of the present invention.

Referring to FIG. 9, the dual-display presentation apparatus 100 further includes a support member 501 on one side of the main body 303, and has a depression for receiving the support member 501 therein. By applying surface mounting technologies to the dual-display presentation apparatus, the main board and the second LCD, which is a primary display, are combined to form an ultra-thin body 303. In this case, the support member 501 can support the dual-display presentation apparatus 100. When the dual-display presentation apparatus is not used, the support member 501 is received in the depression. Thanks to this structure, the overall size of the dual-display presentation apparatus can be reduced and the dual-display presentation apparatus can be conveniently used.

FIG. 10 is a view illustrating an exemplary use for the purpose of general office work of the dual-display presentation apparatus according to one embodiment of the present invention.

Referring to FIG. 10, the auxiliary member 301 having the first LCD 305 disposed on one side thereof and the main body 303 having the second LCD 307 disposed on one side thereof are combined using the connection member (not shown), and the first LCD 305 and the second LCD 307 are adjusted to be directed in the same direction for the purpose of general office work. The first LCD 305 and the second LCD 307 can be used as a dual monitor. The main body 303 has the USB connector (not shown) at the other side thereof, and an external input device 603 can be connected to the USB connector. A user can manipulate the dual-display presentation apparatus using an external keyboard 601.

The present invention is not limited to the above-described embodiments, and those skilled in the art will appreciate that various modifications are possible, without departing from the scope and spirit of the invention.

### INDUSTRIAL APPLICABILITY

Since the dual-display presentation apparatus according to the present invention has two display units, a presenter and an audience member can look at the contents which are being talked about without using additional equipment, so that a deal can be made easily and conveniently, resulting in successful conclusion.

Further, since a user can work using two display units, that is, a user can perform word-processing work using one display unit while viewing research results or retrieved information on the other display unit, job efficiency can be enhanced.

1. A dual-display presentation apparatus, comprising:
an auxiliary member having a first display unit on a side thereof;
a main body having a second display unit on a side thereof and having a support member and a depression for receiving the support member on another side thereof; and
a connection member being a hinge unit combining the auxiliary member and the main body, in which locations of the auxiliary member and the main body can be adjusted by swiveling and tilting the connection member.

2. The dual-display presentation apparatus according to claim 1, further comprising a main board disposed at the other side of the main body, in which the main board and the second display are integrated into a ultra-thin body.

3. The dual-display presentation apparatus according to claim 1, further comprising a selection button disposed at another side of the auxiliary member, for enabling a presenter to perform predetermined functions.
